(19) United States
(12) Patent Application Publication
(10) Pub. No.: US 2007/0235033 A1
(43) Pub. Date: Oct. 11, 2007

(54) HARNESS FOR RESPIRATORY PROTECTION DEVICE

(75) Inventors: Matthew D. Reier, St. Paul, MN (US); Brandon H. Harmon, Murrieta, CA (US); James R. Betz, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,269

(22) Filed: Mar. 31, 2006

(51) Int. Cl. A62B 18/02; A62B 18/08

(52) U.S. Cl. 128/207.11; 128/206.21

(57) ABSTRACT

A harness for securing a face seal assembly to a user's head comprises a lower harness portion and an upper harness portion. The lower harness portion has a plurality of connecting members that are connectable to a lower portion of a face seal assembly. The upper harness portion is separable from the lower harness portion. The upper harness portion comprises a front section having a plurality of connecting members that are connectable to a top portion of the face seal assembly and a rear section adapted to be removably secured to the lower harness portion.

### BACKGROUND

Respiratory protection devices (also referred to as respirators) for providing a breathable air supply to a wearer are used in a variety of different applications. The respirators can be used during fires, military operations, and hazardous industrial applications where the air supply may be contaminated. While the primary purpose of a respirator is to provide a clean air source to the nose and mouth of a wearer for breathing, a respirator may also include eye shields, a face shield, a hood or even a full body suit to further protect the wearer. In a face shield configuration, the respirator includes a face seal assembly which engages a forward portion of a user's face (typically from below the chin, along the face in front of each ear and across the forehead) to form a fluid tight seal around the mouth, nose and eyes of a wearer's face.

A face shield of this type is held onto a user's head by means of a harness which connects to the face shield at various connection points and extends around the back of the user's head. Such a harness typically includes a plurality of adjustable straps so that the face shield can be pulled tightly against the wearer's head and make a good seal. Each strap is often adjustable, and may be separately connected to the face shield. Manual manipulation of straps to achieve adjustment is often difficult once the face shield is mounted on a wearer's head. In addition, a wearer who may don the same face shield on more than one occasion must adjust the straps each time in order to ensure an appropriate and correct fit of the face shield (i.e., a relatively comfortable fit and a fluid-tight seal). The straps and harness, through adjustment, may become entangled in a wearer's hair, which can result in discomfort. In addition, in some environments, the wearer also must wear a helmet or hard hat and the face shield and/or its harness may have components which interfere with the wearing of such additional headgear.

### SUMMARY OF THE INVENTION

A harness for securing a face seal assembly to a user's head comprises a lower harness portion and an upper harness portion. The lower harness portion has a plurality of connecting members that are connectable to a lower portion of the face seal assembly. The upper harness portion is separable from the lower harness portion and comprises a front section and a rear section. The front section has a plurality of connecting members that are connectable to a top portion of the face seal assembly, and the rear section is adapted to be removably secured to the lower harness portion.

This summary is not intended to disclose each disclosed embodiment or every implementation of the concepts presented herein. The figures and the description that follows more particularly exemplify illustrative embodiments.

### GLOSSARY

The terms set forth below will have meaning as defined:

“face seal assembly” means that portion of a face shield respirator that engages a user's face to create a fluid-tight seal between the respirator and user, and may include a seal member engaging the user as well as a supporting structure for that seal member.

“head harness assembly” means a harness for securing a face seal assembly to a user's head that includes at least two separable harness portions, with each harness portion having connecting members thereon.

“connecting members” means those elements extending from a harness portion for use in connecting that harness portion to the face seal assembly.

“fastener point” means each location where one upper harness portion is releasably secured to another lower harness portion.

“fastener element” means a structure or characteristic used for securement of two harness portions together.

“fastener carrier member” means a component bearing one or more fastener elements for use in securing two harness portions together.

### BRIEF DESCRIPTION OF THE DRAWINGS

The concepts presented herein will be further explained with reference to the attached figures, wherein like structure or system elements can be referred to by like reference numerals throughout the several views.

FIG. 1 is a representation of a first embodiment of a head harness assembly of the present invention, as viewed from the back and without connection to an associated respirator face shield.

FIG. 2 is a back view of a lower harness portion of the head harness assembly of FIG. 1.

FIG. 3 is a back view of an upper harness portion of the head harness assembly of FIG. 1.

FIG. 4 is an isometric view of a fastener carrier member used for connecting the lower and upper harness portions of the head harness assembly of FIG. 1.

FIG. 5 is a partial sectional view as taken along lines 5-5 in FIG. 1.

FIG. 6 is a partial sectional view as taken along lines 5-5 in FIG. 1, showing an alternative embodiment for connecting the lower and upper harness portions of the inventive head harness assembly.

FIG. 7 is a sectional view as taken along lines 5-5 in FIG. 1, showing another alternative embodiment for coupling the lower and upper harness portions of the head harness assembly of FIG. 1.

FIG. 8 is a perspective view of the inventive head harness assembly of FIG. 1, connected to an associated face shield and mounted on a wearer's head, as viewed from the back, top and right side thereof.

FIG. 9 is a front view of a user wearing a face shield with the inventive head harness assembly connected thereto.

FIG. 10 is a perspective view, as viewed from the back, top and right side, of the inventive head harness assembly of FIG. 8 (in a first initial harness size configuration).

FIG. 11 is a perspective view, as viewed from the back, top and right side, of the inventive head harness assembly of FIG. 8 (in a second initial harness size configuration).

FIG. 12 is an exploded isometric view of the inventive head harness assembly and an associated face seal assembly.

FIG. 13 is an isometric view of an alternative fastener carrier member for the head harness assembly of the present invention, as taken from the back, top and left side thereof.

FIG. 14 is a rear view of a head harness assembly of the present invention using the fastener carrier member of FIG. 13.

FIG. 15 is a perspective view of the head harness assembly of FIG. 14, as taken from the back, top and right side thereof.

While the above-identified figures set forth several embodiments of the present invention, other embodiments are also contemplated, as noted herein. In all cases, concepts presented herein describe the invention by way of representation and not by limitation. It should be understood that numerous other modifications and embodiments can be devised by those skilled in the art which fall within the scope and spirit of the principles of this invention.

### Detailed Description of the Preferred Embodiments

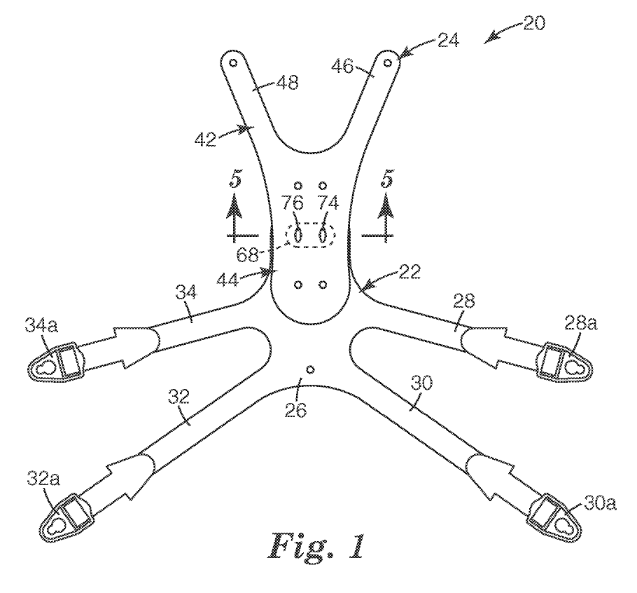

The present invention comprises a head harness assembly which serves as a harness of unique form and operation for securing a face shield assembly to a user's head. In FIG. 1, the head harness assembly is shown alone, without connection to an associated face seal assembly, and is laid generally flat, as viewed from the back.

Harness 20 of FIG. 1 comprises a lower harness portion 22 and an upper harness portion 24. The lower and upper harness portions 22 and 24 are selectively securable together in order to adjust the relative position of the lower harness portion 22 with respect to a top portion of an associated face seal assembly. The lower and upper harness portions 22 and 24 are securable together in alternate configurations to accommodate different sizes of user heads.

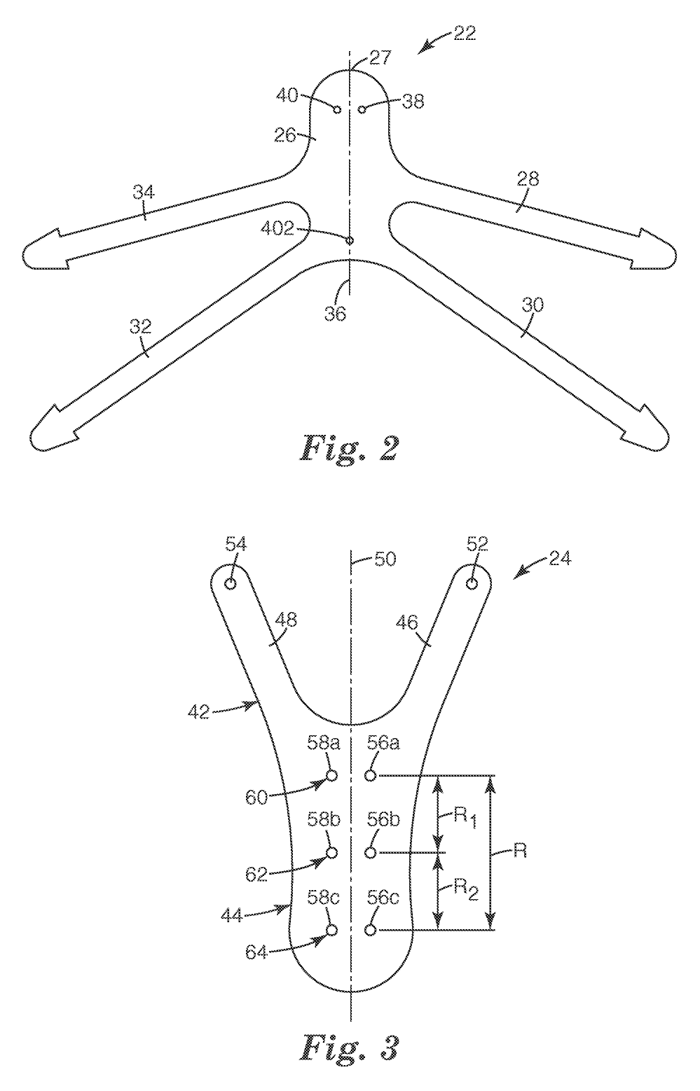

The lower harness portion 22 has a central body portion or back 26 that has an upper end 27 thereof. The lower harness portion 22 also has a plurality of connecting members extending from the back 26 and for use in connecting the lower harness portion 22 to an associated face seal assembly. In the illustrated embodiment, four connecting members 28, 30, 32 and 34 are illustrated. The connecting members 28, 30, 32 and 34 are shown as symmetrical relative to the back 26, along a vertical center line (such as illustrated by center line 36 of the lower harness portion 22 (see FIG. 2)) which bisects the back 26. While four connecting members are illustrated, any suitable number will suffice, so long as the connecting members permit connection to an associated face seal assembly for mounting it on a user's head. In one embodiment (such as illustrated in FIG. 1), each connecting member has an associated connector 28a, 30a, 32a and 34a, which allows adjustment of the extent which that connector is spaced from the back 26 of the lower harness portion 22. For example, free ends of each of the connecting members 28, 30, 32 and 34 may be inserted through a loop or slot in each of their respective connectors 28a, 30a, 32a and 34a for engagement thereto. The amount of connecting member inserted through a slot of its respective connector will determine the distance which the connector extends from the back 26 of the lower harness portion 22. That distance may be shortened by pulling more of the connecting member through its respective connector slot or loop.

In one embodiment, the back 26 of the lower harness portion 22 has a plurality of fastener elements thereon. In the embodiment illustrated in FIG. 2, those fastener elements are shown as a pair 37 of spaced apart apertures 38 and 40. In one embodiment, the apertures 38 and 40 are symmetrically disposed on each side of the center line 36.

FIG. 3 illustrates the upper harness portion 24 of the harness 20. The upper harness portion 24 has a front section 42 and a rear section 44. The front section 42 includes a plurality of connecting members which extend outwardly therefrom and are adapted for connection to a face seal assembly of a face shield. In the embodiment illustrated in FIG. 3, the upper harness portion 24 has two connecting members (connecting members 46 and 48) which are symmetrically disposed with respect to a vertical center line 50 bisecting the upper harness portion 24.

Unlike the connecting members of the lower harness portion 22, the connecting members of the upper harness portion 24 are not independently adjustable in length. At the free ends thereof, however, each connecting member 46 and 48 of the upper harness portion 24 has means for connecting it to a top portion of an associated face seal assembly. In the embodiment illustrated in FIG. 3, apertures 52 and 54 are provided on the connecting members 46 and 48, respectively, for this purpose. The apertures 52 and 54 are likewise disposed symmetrically on each side of the centerline 50. While in the illustrated embodiment, two connecting members 46 and 48 are shown, alternative numbers of connecting members may be provided, so long as they are symmetrically disposed relative to centerline 50 (including even a central connecting member extending along centerline 50, alone or in combination with other connecting members).

The rear section 44 of the upper harness portion 24 includes, in one embodiment, a plurality of fastener elements thereon. As illustrated, the fastener elements may comprise spaced apart apertures 56a and 58a. In one embodiment, the apertures 56a and 58a are disposed symmetrically relative to the centerline 50, as a first pair 60 of apertures. The rear section 44 may include a second pair 62 of spaced apart apertures 56b and 58b, which are likewise disposed relative to the centerline 50, but spaced from the first pair along the centerline 50. The rear section 44 may further include a third pair 64 of spaced apart apertures 56c and 58c, which are similarly disposed, and likewise spaced from the second pair 62 of apertures thereon. While in the illustrative example, three pairs of apertures on the rear section 44 are shown, only two pairs or additional pairs of apertures are also contemplated on the upper harness portion 24.

In one embodiment, the upper and lower harness portions (and their respective connecting members) are made of material that is flexible, yet very stiff. An example of such a material is a high durometer silicone material such as a liquid injected-molded silicone. Other materials that may be suitable would include, for example, thermoplastic elastomers, thin flexible plastics, woven or nonwoven textiles, and other types of rubbers. While the material is flexible, it is not intended that it be elastic in nature.

The lower and upper harness portions 22 and 24 are designed to be removably secured to one another to define the harness 20. For this purpose, each harness portion is, in the embodiment illustrated in FIGS. 1-3, provided with a pair of apertures. The apertures of each pair (e.g., apertures 38 and 40 on the lower harness portion 22 and the apertures 56a and 58a on the upper harness portion 24) are spaced apart the same distance and aligned to mate when laid over one another.

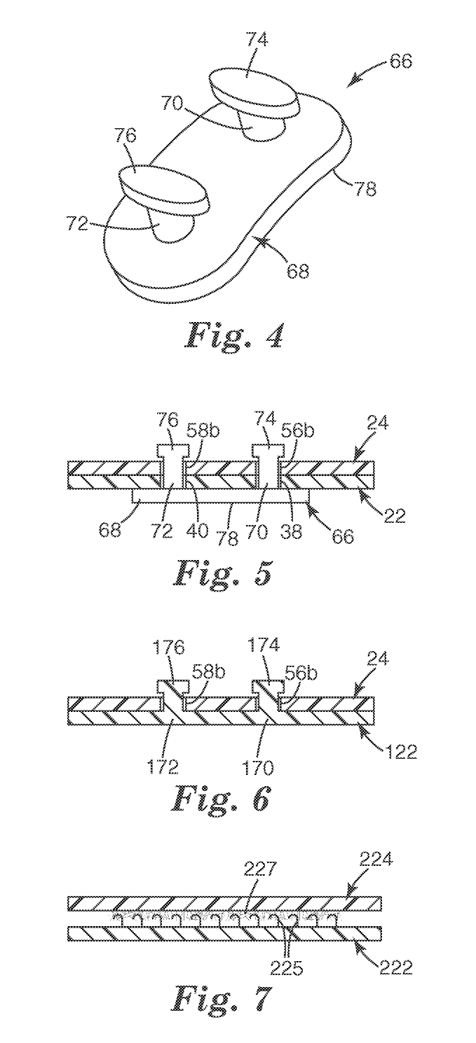

FIG. 4 illustrates a fastener carrier member 66 which has fastener elements thereon that are designed to cooperate with the fastener elements on the lower and upper harness portions 22 and 24. The fastener carrier member 66 has a base 68 from which its fastener elements project as projections 70 and 72. At its free end, each projection 70 and 72 has an enlarged head 74 and 76, respectively. The projections 70 and 72 are relatively short (e.g., less than 0.50 inches high) to provide a low profile connection arrangement. The fastener carrier 66, in one embodiment, is relatively rigid, as compared to the lower and upper harness portions 22 and 24. In one embodiment, the fastener carrier member is formed from a rigid plastic material. Other materials that may be suitable would include, for example, high durometer rubber materials (fairly stiff materials) and metallic materials. Edges of the base 68 are rounded, and bottom side 78 of the base 68 is smooth, since it is in contact with a user's head. In one embodiment, the bottom side 78 has a curvature in one or more dimensions to define a surface which will more comfortably engage a user's head.

FIGS. 1 and 5 illustrate one means for assembly of the lower harness portion 22, upper harness portion 24 and fastener carrier member 66. In FIG. 1, the only portions of the fastener carrier member 66 which are visible are the enlarged heads 74 and 76 of the projections 70 and 72, respectively. In FIG. 1, the base 68 of the fastener carrier member 66 is below the upper and lower harness portions 24 and 22, and is shown in phantom.

To assemble the lower harness portion 22, upper harness portion 24 and fastener carrier member 66, the pair 37 of apertures 38 and 40 of the lower harness portion are aligned with one of the pairs 60, 62 or 64 of apertures of the upper harness portion 24. The projections 70 and 72 on the fastener carrier member are spaced apart the same distance as the paired apertures, and thus can project through the aligned pairs of apertures on the lower and upper harness portions 22 and 24 as illustrated in FIG. 5. The enlarged heads 74 and 76 can be forced through the apertures, but are larger in dimension than the apertures to define a mechanical interlock of the components once assembled. In FIG. 5, the projections 70 and 72 are aligned and inserted through aligned pair 37 of apertures 38 and 40 of the lower harness portion 22 and the second pair 62 of apertures 56b and 58b of the upper harness portion 24. As thus assembled by illustration in FIG. 5, the upper and lower harness portions are secured together to define the harness 20 of FIG. 1. Using paired apertures and projections, the positional relationships between the upper and lower harness portions may be varied discretely, dependant on the number of pairs of apertures provided on the upper harness portion, and the distances between those pairs. At most, a positional adjustment range is available between the outermost pairs of apertures, such as illustrated by range R in FIG. 3, with discrete incremental spacings as illustrated by ranges R₁ and R₂.

Alternative means for connecting the upper and lower harness portions are illustrated, for example, in FIGS. 6 and 7, which correspond to sectional views as taken along lines 5-5 in FIG. 1. For example, in FIG. 6, a lower harness portion 122, (corresponding in all other regards to the lower harness portion 22) includes projections 170 and 172 thereon (instead of apertures 38 and 40), with each projection having an enlarged head 174 and 176, respectively. The projections 170 and 172 are disposed to be aligned with the pairs of apertures on the upper harness portion 24, such as the second pair 62 of apertures 56b and 58b. The enlarged heads 174 and 176 are larger than the apertures 56b and 58b, so once inserted through the apertures 56b and 58b, the heads serve to retain the upper harness portion 24 in engagement with the lower harness portion 22. In this embodiment, a separate fastener carrier member is not required, since two-part mechanical fasteners are provided on the upper and lower harness portions themselves.

Other forms of two-part mechanical fasteners carried on the upper and lower harness portions themselves are also contemplated. For example, an opposed array of two-part mechanical fastener materials, commonly referred to as hook and loop fastener materials, may be used to couple the upper and lower harness portions together. In FIG. 7, a lower harness portion 222 is affixed to an upper harness portion 224. The lower harness portion 222 bears an array of headed stems, or hooks, thereon, while on an opposed facing surface, the upper harness portion 224 has an array or field of “loop” material which is mechanically engageable by the headed stems or hooks. In this embodiment, no paired apertures and projections are required on the upper and lower harness portions, and the positional relationships between the upper and lower harness portions may be varied continuously along the length of the opposed hook and loop material, relative to its longitudinal extent across the harness portions along or adjacent to the centerlines thereof.

Regardless of the form of the fastener elements which are used to connect the lower harness portion 22 and upper harness portion 24, the connection arrangement connects the two so that their respective centerlines 36 and 50 are aligned in a colinear relationship. In addition, the connection arrangement inhibits movement of one of the harness portions relative to the other off of this colinear centerline alignment relationship. For instance, in the embodiment illustrated in FIGS. 1 and 5, providing two projections and related apertures in the harness portions prevents one harness portion from pivoting relative to the other (e.g., from side to side) with respect to their respective centerlines.

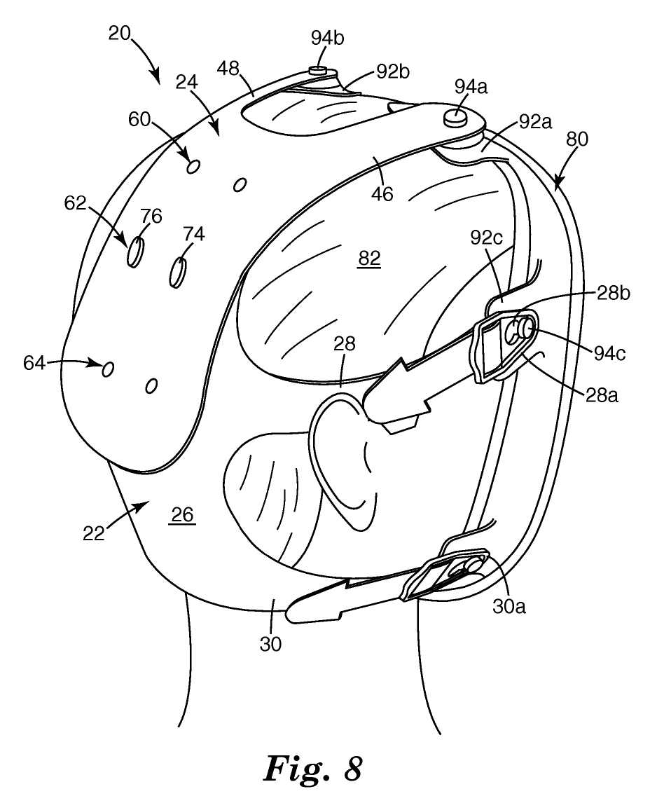

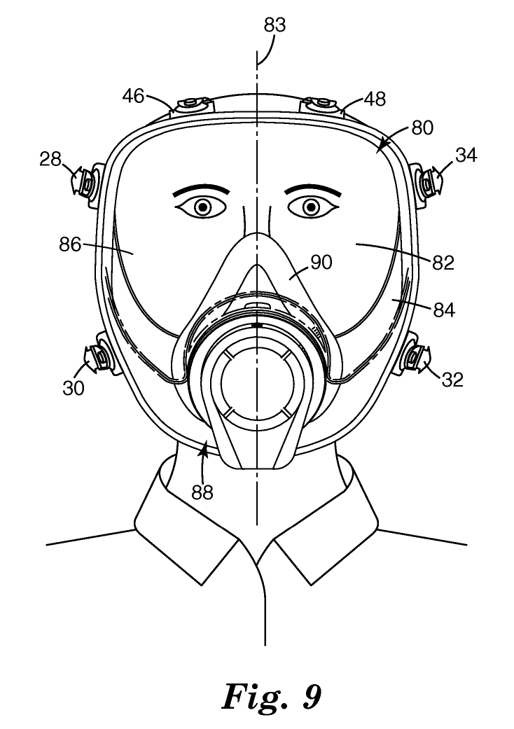

FIGS. 8 and 9 illustrate the inventive harness 20 as mounted to an associated face seal assembly 80, and with the harness 20 and face seal assembly 80 mounted onto a user's head 82. The face seal assembly 80 has a vertical centerline 83, and is typically symmetrically formed relative to the centerline 83. The face seal assembly 80 includes a pliant seal rim 84 which is shaped to engage portions of the wearer's head 82 to form a fluid-tight seal. The face seal assembly 80 may also include a supporting structure or framework adjacent the pliant seal rim 84 for supporting it and defining its shape, aiding in making effective the fluid-tight seal, and/or connecting to the harness 20. When so connected, the centerline 83 of the face seal assembly 80 may be aligned coplanar with the centerlines 36 and 50 of the harness portions 22 and 24. The face seal assembly 80 includes a viewing lens 86 and associated respiratory components and structure 88 (which may include, for example, one or more filtering elements, respiratory ports, conduit connections for supplied air, power or communications equipment, and the like). The face seal assembly 80 may also include an internal nose and mouth seal assembly 90, as illustrated generally in FIG. 9.

One means for affixing the connecting members of the lower and upper harness portions 22 and 24 to the face seal assembly 80 is illustrated in FIG. 8. The seal rim 84, in the illustrated embodiment, has a plurality of rearwardly projecting tabs, each of which has an outwardly projecting extension or button thereon. Illustrative tabs 92a and 92b are shown adjacent a top portion of the face seal assembly 80 (generally adjacent and over a user's forehead), while an illustrative tab 92c is illustrated adjacent a lower portion of the seal rim 84. Each of the tab portions 92a, 92b and 92c, has a respective extension 94a, 94b and 94c thereon. In one embodiment, the tabs are symmetrically disposed relative to the centerline 83 of the face seal assembly 80.

The apertures 52 and 54 on the connecting members 46 and 48 of the upper harness portion 24 are shaped to be selectively received over and connected to the projections 94a and 94b on the tabs 92a and 92b, respectively, thereby to removably affix the upper harness portion 24 to a top part of the face seal assembly 80. As shown, no buckles or other fastener components are necessary for this connection. The projections 94a and 94b are relatively short (e.g., less than 0.50 inches high), and thus the connecting members 46 and 48 are affixed to the face seal assembly 80 at connection points having relatively low profiles. This facilitates use of the inventive head harness assembly with a hard hat or other headgear without undue interference thereto. This simple means of connection also minimizes possible entanglement with a user's hair.

The connecting members of the lower harness portion 22 have connectors which are formed to selectively engage the projections on their respective tabs of the face seal assembly 80. For example, as seen in FIG. 8, connector 28a has an aperture 28b which is shaped to receive and engage the projection 94c on the tab 92c. In one embodiment, although not specifically shown, the connectors 30a, 32a and 34a of the other connecting members 30, 32 and 34 of the lower harness portion 22 also have apertures which likewise selectively engage a projection on respective tabs of the face assembly 80 to secure each connecting member to the face seal assembly 80. Each connecting member of the lower harness portion 22 is, as mentioned above, adjustable in length. Once the connector of a connecting member is mounted to its respective tab, a free end of the connecting member may be manipulated (i.e., pulled) to tighten the connecting member, thus shortening the distance between the back 26 of the lower harness portion 22 and the tab for that tightened connecting member. In this way, a user can cinch up the head harness assembly to make effective a fluid-tight seal by urging the pliant seal rim 84 against the user's head.

In the embodiment illustrated in FIG. 8, the pair 37 of apertures (not shown) on the lower harness portion 22 are aligned and coupled with the second pair 62 of apertures on the upper harness portion 24 and the enlarged heads 74 and 76 of the projections of the fastener carrier member are seen as inserted through those apertures. The lower and upper harness portions 22 and 24 are thus coupled in a fixed spatial relationship with respect to one another, to define an initial harness size for coupling to the face seal assembly 80 via its respective connecting members. That initial harness size may be selected by a user for his or her head, and not changed again, with the only adjustment during use and donning of the head harness assembly being by means of adjusting the length of the connecting members of the lower harness portion 22. However, if a user decides that the initial harness size is too small or too large, it may be adjusted by reconnecting the lower and upper harness portions 22 and 24 using different pairs of apertures on the upper harness portion 24 (e.g., by using the first pair 60 of apertures or the third pair 64 of apertures on the upper harness portion 24). Alternatively, a second upper harness portion can be substituted for the upper harness portion 24 shown, wherein the second harness portion has paired apertures that are spaced differently, thereby allowing a user to change the initial harness size selected for the head harness assembly.

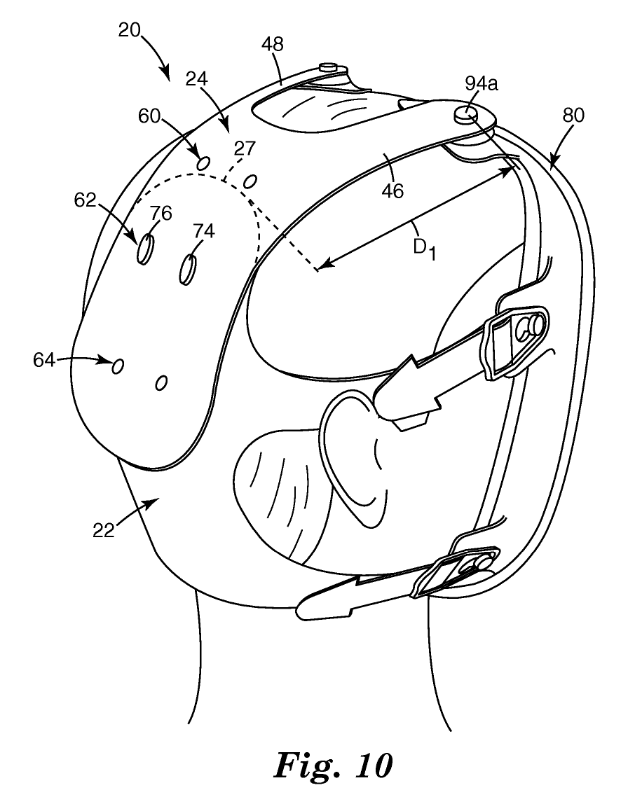

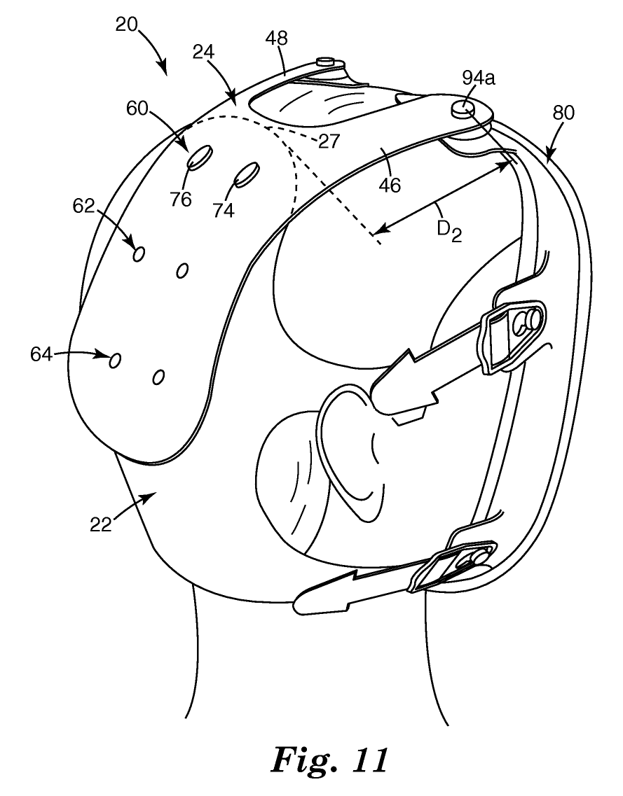

FIGS. 10 and 11 illustrate alternative initial harness positions for the head harness assembly. FIG. 10 shows the head harness assembly of FIG. 8 in an initial harness position defined by using the second pair 62 of apertures on the upper harness portion 24, for connection to the lower harness portion 22. In this arrangement, an upper end 27 of the back 26 of the lower harness portion 24 is spaced a distance D₁ from a top part of the face seal assembly 80 (as defined in this exemplary embodiment by the projection 94a thereon). In FIG. 10, that distance is illustrated as distance D₁ extending between upper end 27 and projection 94a. FIG. 11 illustrates an alternative initial harness position, as discussed above, using the first pair 60 of apertures on the upper harness portion 24. In this alternative position, the harness assumes an alternative harness size, where the back 26 of the lower harness portion 22 is now closer to the top part of the face seal assembly 80 (e.g., for a smaller head size), and the distance is smaller between the upper edge 27 of the back 26 of the lower harness portion 22 and a top part of the face seal assembly 80. As illustrated, this distance is shown as distance D₂ between upper edge 27 and the projection 94a. Distance D₁ is greater than distance D₂. If the lower and upper harness portions 22 and 24 were connected using the third pair 64 of apertures on the upper harness portion 24, a third distance D₃ would be defined between the upper edge 27 and a top part of the face seal assembly 80. Distance D₃ would be greater than distance D₁.

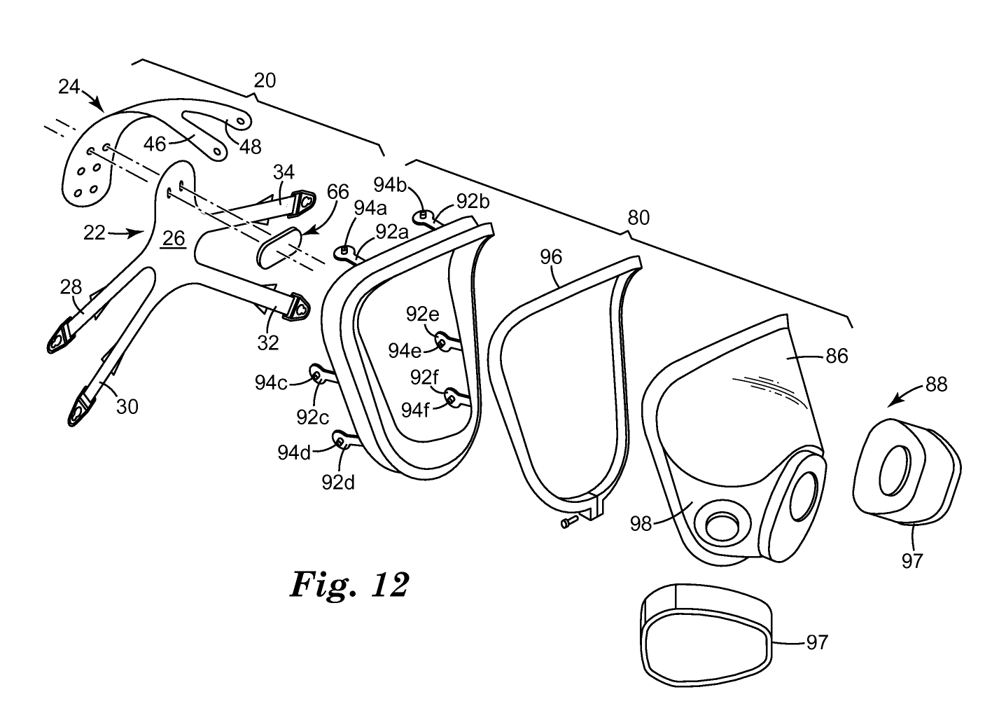

FIG. 12 is an exploded isometric view of the inventive harness 20 and an associated face seal assembly 80. As noted above, the pliant rim 84 may include supporting structure such as a frame assembly 96 which is used not only to assist in defining the shape of the face seal assembly, but also to secure the viewing lens 86 and respiratory structure 88 to the pliant seal rim 84. As illustrated in FIG. 12, the respiratory structure 88 may include one or more filter cartridges 97 which are mountable onto a chassis 98 which supports such respiratory components, and the lens 86. Features of the chassis 98 and lens 86 are disclosed in copending application Ser. No. ______ (attorney docket no. 61675US002) and Ser. No. ______ (attorney docket no. 61975US002), owned by Applicants' assignee and incorporated herein by reference.

FIG. 12 also illustrates the connectivity relationship between the lower harness portion 22, upper harness portion 24 and fastener carrier member 66. As noted above, the bottom side 78 of the fastener carrier member 66 contacts the back of the user's head. This area of contact is adjacent the crown of a user's head.

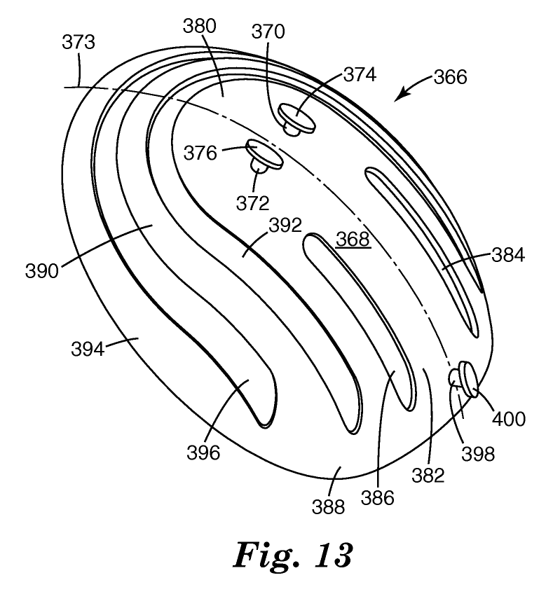

An alternative embodiment for the fastener carrier member 66 is illustrated in FIG. 13 as a dome-shaped fastener carrier member 366. In this embodiment, the fastener carrier member 366 is enlarged and formed to be adjustable to conform to the crown curvature of a user's head. The fastener carrier member 366 includes a base 368, and is formed, in one embodiment, from a rigid plastic material. Other materials that may be suitable would include, for example, high durometer rubber materials (fairly stiff materials) and metallic materials. The base 368 has a pair of projections 370 and 372 extending therefrom, which are aligned and spaced for cooperative engagement with the pairs of apertures on the lower and upper harness portions 22 and 24. The projections are disposed symmetrically on each side of a centerline 373 of the fastener carrier member 366. Each of the projections 370 and 372 has an enlarged head 374 and 376 at its outer end thereof, in order to make affirmative the engagement between fastener carrier member 366 and apertures of the lower and upper harness portions 22 and 24.

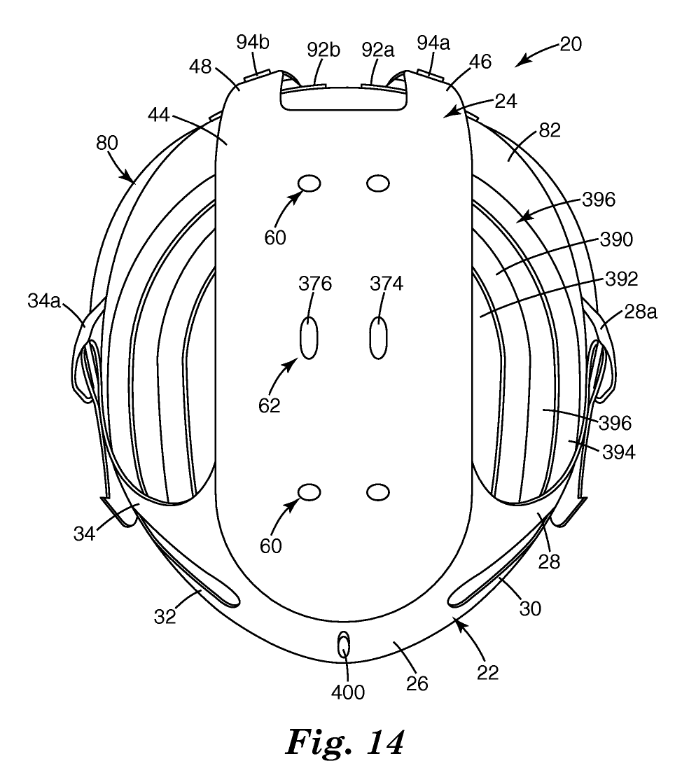

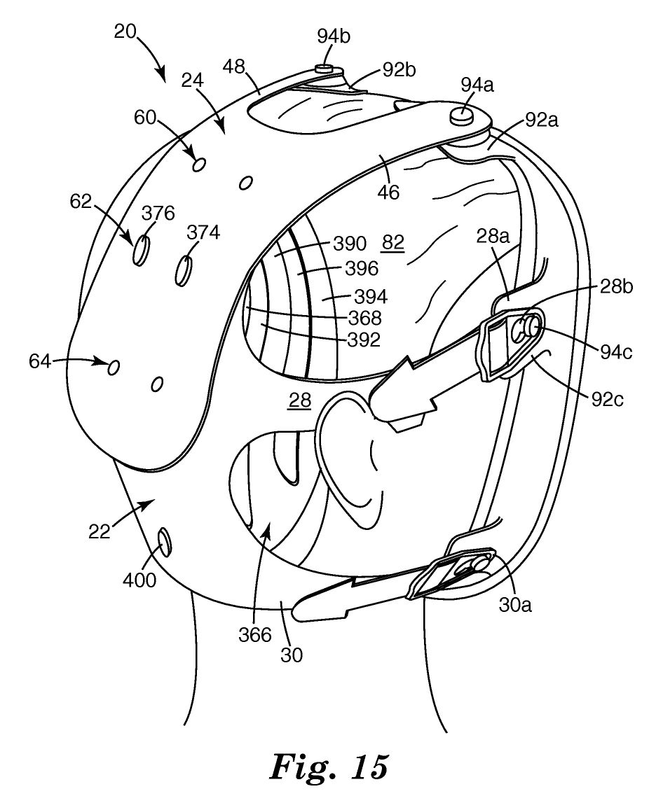

The fastener carrier member 366 forms a cradle for engaging and conforming to different crown curvatures of different users. The base 368 of the fastener carrier member 366 is formed with a central portion 380 (bearing the projections 370 and 372) and which generally serves the purpose of base 68 of fastener carrier member 66. The base 368 has a lower extension 382 projecting from the central portion 380. The lower extension 382 may have a pair of opposed symmetrically aligned cut outs 384 and 386 therethrough. The central portion 380 and lower extension 382 are formed to engage the crown and back of a user's head, and when assembled with the lower and upper harness portions 22 and 24, are covered by the back 26 of the lower harness portion 24, as seen in FIGS. 14 and 15.

The base 368 has a lower lateral edge portion 388 (at a lower end of the lower extension 382). A first conforming panel 390 has its ends attached to the lower lateral edge portion 388 and extends upwardly therefrom. The first panel is shaped to be spaced from the lower extension 382 and central portion 380, thereby defining a first cutout 392 therebetween. A second conforming panel 394 is spaced from the first panel 390, and also attached at its ends to the lower lateral edge portion 388. The second panel 394 is shaped to be spaced from the first panel 390, to define a second cutout 396 therebetween. Each of the panels 390 and 394 thus extends upwardly from the lower lateral edge portion 388 and curves over the top of the central portion 380 of the base 368, but are continually spaced therefrom and from each other by the cutouts 392 and 396. The opposed edges of the portions of the base 368 across each cutout 384, 386, 392 and 396 are formed to permit curvature and conformance of the base 368 to the shape of the crown of a user's head, and to adapt to different shapes for different users. The first and second panels 390 and 394 are movable relative to the central portion 380 of the base 368, as well as with respect to each other to change the shape of the dome defined by the cradle, as necessary to conform to the shape of a user's head. As illustrated in FIG. 13, the projections 370 and 372, cutouts 384 and 386, and panels 390 and 394 are symmetrically disposed relative to the centerline 373 extending along the fastener carrier member 366. When connected with the lower and upper harness portions 22 and 24, as illustrated in FIGS. 14 and 15, the centerline 373 of the fastener carrier member 366 is colinear with the centerline 36 of the lower harness portion 22 (FIG. 2) and the centerline 50 of the upper harness portion 24 (FIG. 3). While the illustrated embodiment includes two moveable panels 390 and 394, along with associated cutouts, any number of panels may suffice to achieve the desired reading conformability of the base 368 to the shape of a user's head. Other geometries for the base are also contemplated, so long as the desired conformability is attained.

In one embodiment, a lower projection 398 is provided on the base 368. The lower projection 398 has an enlarged head 400. This projection is formed to be received within an aperture 402 on the body 26 of the lower harness portion 22 (see FIG. 2) to further engage those components together.

As illustrated in FIGS. 14 and 15, forming the fastener carrier member 366 in the form of a head cradle located between the lower harness portion 22 and the user's head provides a cradle with a base curvature operative to comfortably match the crown shape of the user's head. This feature aids in further facilitating proper positioning of the inventive harnessing system on a user, through conformability of the domed shape of the fastener carrier member 366, reduced friction of its surface on the user's head, and distribution of the load of harness on a user's head. The head cradle fits on the crown of a user's head and provides a tactile and visual reference as to the proper location of the harness during donning thereof. Because of its conformability, one head cradle can accommodate many different head shapes and sizes since the curvature of the dome is allowed to change due to the geometry used to define the base of the head cradle and the flexibility of the base. The base is formed of material with a low coefficient of friction while allowing it to slide easily on the user's head without pulling or tangling in the user's hair. Since the curvature of the head cradle is matched to the curvature of the user's head upon mounting, the head cradle allows the harness load to be distributed over a larger area on the user's head, which provides a more even pressure distribution and the minimization of possible high pressure points.

The head harness assembly of the present invention includes an upper harness portion which, in one embodiment, is a Y-shaped strap which combines two top connecting members into one before its point of adjustment relative to the lower harness portion. This provides an advantage because there is only one adjustment point and the straps (i.e., connecting members) of the upper harness portion are equally tensioned while still pulling the face seal assembly at two different locations. A properly donned harness should be centered (side to side) on the user's head. When two separately adjustable straps are used along a top part of a respirator harness, this centering may not be achieved because one strap may be adjusted to a different length than the other. With a single adjustment point (such as achieved by the interconnection of the upper and lower harness portions of the present invention) the harness is centered on the user's head because both of the connecting members on the upper harness portion are adjusted equally.

The connection between the lower and upper harness portions by using discrete pairs of fastener elements (such as in the embodiment illustrated in FIG. 8) allows adjustment of the distance of the lower harness portion relative to a top part of the face seal assembly at a discrete series of distances. The ability to achieve consistent adjustment, a set adjustment point and the elimination of buckles or other obtrusive fastening components adjacent a top part of the face seal assembly, are all advantages presented by means of the two-part harness system of the present invention. Before a user may wear a respiratory protection system embodying the harness of the present invention in a hazardous environment, the fit of the respirator must be verified. As part of the fit-testing process, the user adjusts the fastener elements so that the harness sits in the appropriate location on the user's head and a suitable airtight fit is obtained. This location is dictated by the length of the top straps and will be consistent from one donning to the next due to the specific and discrete adjustment location selected by the user. This location will remain set since this adjustment is not necessary for rapid and consistent fit in donning and doffing of the respiratory device. Manipulation of the connecting members on the lower harness portion is then all that is necessary in order to don and doff the respiratory device. Since no fit adjustment components are disposed along the top part of the face seal assembly, there is no need for adjustable buckles or other fastener components at that location. The elimination of such components is advantageous, since they can interfere with proper positioning of a hard hat and would otherwise be in locations susceptible to hair entanglement during adjustment period.

Although the present invention has been described with reference to preferred embodiments, workers skilled in the art will recognize that changes may be made in form and detail without departing from the spirit and scope of the invention.

What is claimed is:

1. A harness for securing a face seal assembly to a user's head, the harness comprising:
a lower harness portion having a plurality of connecting members and that are connectable to a lower portion of the face seal assembly; and
an upper harness portion that is separable from the lower harness portion, the upper harness portion comprising:
a front section having a plurality of connecting members that are connectable to a top portion of the face seal assembly; and
a rear section adapted to be removably secured to the lower harness portion.

2. The harness of claim 1 wherein the rear section of the upper harness portion and the lower harness portion are secured together at a plurality of fastener points.

3. The harness of claim 1 wherein the rear section of the upper harness portion and the lower harness portion are secured together in various harness size positions to vary the distance from the top portion of the face seal assembly to the lower harness portion.

4. The harness of claim 3 wherein the distance is discretely variable over a range of available distances.

5. The harness of claim 3 wherein the distance is continuously variable over a range of available distances.

6. The harness of claim 1 wherein the rear section of the upper harness portion has a first plurality of fastener elements and the lower harness portion has a second plurality of fastener elements which cooperate with the first plurality to secure the upper and lower harness portions together.

7. The harness of claim 6 wherein one of the first and second fastener elements comprises male fastener elements and the other of the first and second fastener elements comprises female fastener elements.

8. The harness of claim 6, and further comprising:
a fastener carrier member having a third plurality of fastener elements which cooperate with the first and second pluralities of fastener elements to secure the upper and lower harness portions together.

9. The harness of claim 8 wherein the first and second fastener elements comprise apertures, and the third fastener elements comprise projections from the fastener carrier adapted to be removably received within the apertures.

10. The harness of claim 8 wherein the fastener carrier member comprises a cradle formed to adapt to the curvature of a crown of a user's head.

11. The harness of claim 1 wherein the connecting member on the front section of the upper harness portion is detachably affixed to the top portion of the face seal assembly.

12. The harness of claim 11 wherein the connecting member on the front section of the upper harness portion has a relatively low profile.

13. The harness of claim 1 wherein each of the connecting members on the lower harness portion is detachably affixed to the lower portion of the face seal assembly.

14. The harness of claim 1, wherein the face seal assembly is bisected by a vertical centerline, and wherein the plurality of connecting members of the front section of the upper harness portion are affixed to the top portion of the face seal assembly and symmetrically disposed thereto relative to the centerline of the face seal assembly.

15. The harness of claim 1 wherein each of the connecting members on the lower harness portion is variable in length.

16. The harness of claim 1 wherein the upper harness portion is a first upper harness portion, and wherein, when the rear section of the first upper harness portion is fastened to the lower harness portion, a first distance is established between the top portion of the face seal assembly and the lower harness portion, and further comprising:
a second upper harness portion that is separable from the lower harness portion instead of the first upper harness portion, the second upper harness portion comprising:
a front section having at least one connecting member affixed to the top portion of the face seal assembly; and
a rear section adapted to be removably fastened to the lower harness portion, wherein, when the rear section of the second upper harness portion is fastened to the lower harness portion, a second distance different from the first distance is established between the top portion of the face seal assembly and the lower harness portion.

17. A respiratory protection device comprising:
a face seal assembly having a lower portion and a top portion, the face seal bisected by a vertical centerline, and the face seal assembly being symmetrical on each side of the centerline; and
a harness for securing the face seal assembly to a user's head, the harness comprising:
a lower harness portion having a back and a plurality of connecting members extending between the back and the lower portion of the face seal assembly; and
an upper harness portion comprising:
a front section affixed to the top portion of the face seal assembly at at least two top connections, each top connection being located symmetrically about the face seal assembly; and
a rear section connected to the back of the lower harness portion at at least two connection points, the rear section of the upper harness portion being connectable to the back of the lower harness portion in a plurality of connection positions to vary the distance from the top portion of the face seal assembly to the back of the lower harness portion.
